(19) United States
(12) Patent Application Publication
(10) Pub. No.: US 2016/0322744 A1
(43) Pub. Date: Nov. 3, 2016

(54) VARIABLE GEOMETRY NON-MECHANICAL DEVICE CONNECTOR INTERFACES

(71) Applicant: Standard Innovation Corporation, Ottawa (CA)

(72) Inventor: Bruce Donald Murison, North Gower, CA (US)

(21) Appl. No.: 15/144,151

(22) Filed: May 2, 2016

Related U.S. Application Data
(60) Provisional application No. 62/155,643, filed on May 1, 2015.

(51) Int. Cl. H01R 13/62; H01R 13/66; H01R 43/26

(52) U.S. Cl. CPC H01R 13/6205; H01R 43/26; H01R 13/665

(57) ABSTRACT

A magnetic connector system is provided. The magnetic connector system includes a first connector assembly including a magnet and a first plurality of electrical contacts; and a second connector assembly including a second plurality of electrical contacts; the second plurality of electrical contacts being adapted to mate with the first plurality of electrical contacts to provide an electrical connection; wherein when the first and second connector assemblies are aligned and brought into proximity the magnetic attraction of the magnet within the first connector assembly provides connective force to the second connector assembly and a magnetic circuit from the magnet is completed through the first plurality of electrical contacts and the second plurality of electrical contacts. Connector assemblies and devices and cables including the same are also provided.

### RELATED APPLICATION

This application claims the benefit of the filing date of U.S. Provisional Patent Application No. 62/155,643, filed on May 1, 2015, the contents of which is incorporated herein by reference in its entirety.

### FIELD OF THE INVENTION

This invention relates to electrical connectors and more particularly to non-mechanical magnetically coupled electrical connectors with uniform or variable geometry contacts.

### BACKGROUND OF THE INVENTION

Electronic devices have evolved in the past two decades from typically large bulky boxes such as set-top boxes, desktop computers, etc. to a wide variety of portable electronic devices such as smartphones, multimedia players, and tablet PCs. Now, with the advancement of “light” adaptive software operating systems and the availability of increasingly miniaturized hardware components, portable devices which are easily carried are being augmented by and potentially replaced by a range of mobile devices small enough to be worn on or otherwise attached to a person's body. Accordingly, users are increasingly going to employ a combination of portable and wearable devices. However, as such devices are increasingly smaller in size, lighter and cheaper, they place additional design constraints above and beyond those of either mimicking a traditionally worn artifact and its features, e.g. a watch, and/or making sleek or unobtrusive such as biometric data acquisition, e.g. blood pressure, heart rate, glucose level, etc., and biomedical devices, e.g. insulin pumps, drug infusers, etc.

Core to all of these products is the requirement for electrical power in order for the electronics, microelectromechanical systems (MEMS) etc. to operate and function. Whilst this, predominantly DC power, is provided by batteries enclosed within the device itself, or closely associated with it, these require recharging if the user is to be saved the hassle and complexity of replacing the batteries. Accordingly, DC power must be periodically provided to the device in order to recharge the battery or batteries based upon the capacity of battery or batteries, power consumption of the device, and its usage by the user.

One approach within the prior art is to use DC power supplied from a transformer connected to a conventional AC power supply or DC power supplied from another electronic device which itself is permanently or periodically connected a conventional AC power supply. For example, devices are commonly connected to a user's laptop computer via standardized interfaces where the laptop is itself connected to AC power supply via a transformer. Typically, the portable electronic device will comprise a female connector that couples to a male connector on the cable from the transformer or another electronic device. This female connector is typically attached to the housing of the portable or wearable electronic device and a printed circuit board of the internal electronics of the device.

Damage can occur to the conventional power connection in a number of ways. One common way is simply inserting the male connector into the female connector, and whilst many connector designs have evolved to remove bendable pins, as connectors have been reduced in size to meet evolving demands of portable and now wearable electronic devices, then these entire assemblies can be damaged. In other instances, damage occurs when any of the components, e.g. the device, male connector, cable, transformer, etc., is inadvertently pulled away from other components by a non-axial force. In many instances the power connections are now integrated into the same connectors as data port, and damage to these other types of connections can also occur in the manners described above even when discrete from power connections.

Accordingly, within the prior art, magnetic connectors have been described and deployed in order to eliminate the traditional male—female connector/socket—plug connector designs such that essentially two elements connect without physical engagement of “projections” in one with “recesses” in the other. In general, the surface area of the two magnetically attracted halves of the connector determines the number of magnetic flux lines and therefore the magnetic holding force between them. Accordingly, the holding force is proportional to the contact area between the two magnetically attracted halves, and hence to have a strong force holding the two magnetically attracted halves together, the two magnetically attracted halves want to be as large as possible. However, a goal for many portable electronic devices and wearable electronic devices is to minimize physical dimensions, especially thickness, whilst maximizing battery capacity, and lowering costs. As such, these goals tend to run counter to the design requirements for magnetic connectors within the art.

It would be beneficial, therefore, to provide designers of portable and wearable electronic devices with a magnetic connector design methodology that allowed for optimizing magnetic retention force within a given footprint. It would be further beneficial for such a methodology to allow designers flexibility in the design of the connectors such that additional design objectives may be met including, but not limited to, aesthetics, low cost, flexibility in design, compatibility with waterproofing methodologies etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to electrical connectors and more particularly to provide non-mechanical magnetically coupled electrical connectors with uniform or variable geometry contacts.

In accordance with one aspect, there is provided a method of mating two electrical connectors to provide an electrical connection and a magnetic connection therebetween, the method comprising: bringing a first electrical connector comprising a magnet and a first plurality of electrical contacts into proximity with a second electrical connector comprising a second plurality of electrical contacts such that the first plurality of electrical contacts mates with the second plurality of electrical contacts to provide the electrical connection, and a magnetic circuit is completed from the magnet via the first plurality of electrical contacts and the second plurality of electrical contacts to provide the magnetic connection.

In accordance with another aspect, there is provided an electrical connector comprising a first plurality of electrical contacts and configured to be electrically and magnetically connected to a second electrical connector comprising a second plurality of electrical contacts, wherein one of the electrical connector and the second electrical connector comprises a magnet, such that when the electrical connector is brought into proximity with the second electrical connector, the first plurality of electrical contacts mates with the second plurality of electrical contacts to provide an electrical connection and a magnetic circuit is completed from the magnet via the first plurality of electrical contacts and the second plurality of electrical contacts to provide a magnetic connection.

In accordance with yet another aspect, there is provided a magnetic connector system comprising: a first connector assembly comprising a magnet and a first plurality of electrical contacts; and a second connector assembly comprising a second plurality of electrical contacts; the second plurality of electrical contacts being adapted to mate with the first plurality of electrical contacts to provide an electrical connection; wherein when the first and second connector assemblies are aligned and brought into proximity the magnetic attraction of the magnet within the first connector assembly provides connective force to the second connector assembly and a magnetic circuit from the magnet is completed through the first plurality of electrical contacts and the second plurality of electrical contacts.

In accordance with still yet another aspect, there is provided a connector assembly comprising: a magnet; and a first plurality of electrical contacts; wherein when the connector assembly is aligned and brought into proximity with a second connector assembly comprising a second plurality of electrical contacts the magnetic attraction of the magnet within the connector assembly provides connective force to the second connector assembly and a magnetic circuit from the magnet is completed through the first plurality of electrical contacts within the connector assembly and the second plurality of electrical contacts within the second connector assembly.

In accordance with another aspect, there is provided a connector assembly comprising: a first plurality of electrical contacts; wherein when the connector assembly is aligned and brought into proximity with a second connector assembly comprising a magnet and a second plurality of electrical contacts the magnetic attraction of the magnet within the second connector assembly provides connective force to the connector assembly and a magnetic circuit from the magnet is completed through the first plurality of electrical contacts within the connector assembly and the second plurality of electrical contacts within the second connector assembly.

In accordance with another aspect, there is provided a device comprising a first connector assembly configured to interact with a second connector assembly disposed at the end of a cable to be connected to the device for charging and/or communicating with the device, wherein: the first connector assembly comprises a first plurality of electrical contacts; the second connector assembly comprises a second plurality of electrical contacts; the second plurality of electrical contacts being adapted to mate with the first plurality of electrical contacts to provide an electrical connection; wherein one of the first connector assembly and the second connector assembly comprises a magnet; wherein when the first and second connector assemblies are aligned and brought into proximity the magnetic attraction of the magnet within one of the first connector assembly and the second connector assembly provides connective force to the other of the first connector assembly and the second connector assembly, and a magnetic circuit from the magnet is completed through the first plurality of electrical contacts and the second plurality of electrical contacts.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts typical electrical power interfaces for electronic devices according to the prior art;

FIG. 2 depicts an electrical connector configuration according to an embodiment of the invention;

FIG. 3 depicts a realization of the electrical connector configuration according to the embodiment of the invention depicted in FIG. 2;

FIG. 4 depicts a connector and device realization of the electrical connector configuration according to the embodiment of the invention depicted in FIG. 2;

FIG. 5 depicts an electrical connector configuration according to an embodiment of the invention;

FIG. 6A depicts an electrical connector configuration according to an embodiment of the invention;

FIG. 6B depicts an electrical connector configuration according to an embodiment of the invention;

FIG. 7 depicts an electrical connector configuration according to an embodiment of the invention;

FIG. 8 depicts an electrical connector configuration according to an embodiment of the invention;

FIGS. 9A and 9B depict electrical contact configurations according to embodiments of the invention as implemented with logos upon a device to be connected to a connector;

FIG. 10 depicts electrical contact configurations according to embodiments of the invention as implemented with logos upon a device to be connected to a connector;

FIG. 11 depicts an electrical connector configuration according to an embodiment of the invention;

FIG. 12 depicts an electrical connector configuration according to an embodiment of the invention;

FIG. 13 depicts an electrical connector configuration according to an embodiment of the invention;

FIG. 14 depicts an electrical connector configuration according to an embodiment of the invention; and

FIG. 15 depicts a realization of an electrical connector configuration according to the embodiment of the invention depicted in FIG. 14.

### DETAILED DESCRIPTION

The present invention is directed to electrical connectors and more particularly to non-mechanical magnetically coupled electrical connectors with uniform or variable geometry contacts.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes, but is not limited to, devices such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “user” as used herein may refer to, but is not limited to, an individual. This includes, but is not limited to, private individuals, employees of organizations and/or enterprises, members of community organizations, members of charity organizations, men, women, children, teenagers, and animals. In its broadest sense the user may further include, but not be limited to, mechanical systems, robotic systems, android systems, etc. that may be characterised by an ability to manipulate first and second elements to make a connection between them wherein either/both of the first and second elements may form part of said mechanical, robotic, android systems etc.

A “wearable electronic device” (WED) or “wearable sensor” relates to miniature electronic devices that are worn by the user including those under, within, with or on top of clothing and are part of a broader general class of wearable technology (the broader class including devices such as “wearable computers” which are directed to general or special purpose information technologies and media development). Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

In accordance with one embodiment, there is provided a method of mating two electrical connectors to provide an electrical connection and a magnetic connection therebetween, the method comprising: bringing a first electrical connector comprising a magnet and a first plurality of electrical contacts into proximity with a second electrical connector comprising a second plurality of electrical contacts such that the first plurality of electrical contacts mates with the second plurality of electrical contacts to provide the electrical connection, and a magnetic circuit is completed from the magnet via the first plurality of electrical contacts and the second plurality of electrical contacts to provide the magnetic connection.

In accordance with another embodiment, there is provided an electrical connector comprising a first plurality of electrical contacts and configured to be electrically and magnetically connected to a second electrical connector comprising a second plurality of electrical contacts, wherein one of the electrical connector and the second electrical connector comprises a magnet, such that when the electrical connector is brought into proximity with the second electrical connector, the first plurality of electrical contacts mates with the second plurality of electrical contacts to provide an electrical connection and a magnetic circuit is completed from the magnet via the first plurality of electrical contacts and the second plurality of electrical contacts to provide a magnetic connection.

In another embodiment, the magnetic circuit is completed from the magnet solely via the first plurality of electrical contacts and the second plurality of electrical contacts.

In accordance with yet another embodiment, there is provided a magnetic connector system comprising: a first connector assembly comprising a magnet and a first plurality of electrical contacts; and a second connector assembly comprising a second plurality of electrical contacts; the second plurality of electrical contacts being adapted to mate with the first plurality of electrical contacts to provide an electrical connection; wherein when the first and second connector assemblies are aligned and brought into proximity the magnetic attraction of the magnet within the first connector assembly provides connective force to the second connector assembly and a magnetic circuit from the magnet is completed through the first plurality of electrical contacts and the second plurality of electrical contacts. In another embodiment, the first connector assembly comprises a first body housing the magnet and the first plurality of electrical contacts, the first plurality of electrical contacts passing through corresponding openings in an outer surface of the first body and having a first predetermined physical relationship; and the second connector assembly comprises a second body housing the second plurality of electrical contacts, the second plurality of electrical contacts passing through corresponding openings in an outer surface of the second body and having a second predetermined physical relationship. In yet another embodiment, the first plurality of electrical contacts comprises a first electrical contact and a second electrical contact, the second plurality of electrical contacts comprises a third electrical contact and a fourth electrical contact, and when the first and second connector assemblies are aligned and brought into proximity, the first electrical contact mates with one of the third electrical contact and fourth electrical contact; and the second electrical contact mates with the other of the third electrical contact and fourth electrical contact. In still yet another embodiment, the first body and the second body are shaped such that the magnetic circuit can be completed with only one alignment of the first body and the second body. In another embodiment, the third and fourth electrical contacts within the second body can be magnetically coupled to one another but are electrically isolated from one another. In yet another embodiment, the magnet is electrically connected to one of the first and second electrical contacts. In still yet another embodiment, at least one of the first and second electrical contacts and the third and fourth electrical contacts is shaped to form one or more predetermined portions of one of an icon and an image associated with one of a brand and a manufacturer of an item of electrical equipment to which the magnetic connector system relates. In another embodiment, one of the first connector assembly and the second connector assembly is housed within a device, and the other of the first connector assembly and the second connector assembly is housed within a cable for charging and/or communicating with the device. In another embodiment, the magnetic circuit from the magnet is completed solely via the first plurality of electrical contacts and the second plurality of electrical contacts.

In accordance with another embodiment, there is provided a connector assembly comprising: a magnet; and a first plurality of electrical contacts; wherein when the connector assembly is aligned and brought into proximity with a second connector assembly comprising a second plurality of electrical contacts the magnetic attraction of the magnet within the connector assembly provides connective force to the second connector assembly and a magnetic circuit from the magnet is completed through the first plurality of electrical contacts within the connector assembly and the second plurality of electrical contacts within the second connector assembly. In another embodiment, the connector assembly comprises a first body housing the magnet and the first plurality of electrical contacts, the first plurality of electrical contacts passing through corresponding openings in an outer surface of the first body and having a first predetermined physical relationship; and the second connector assembly comprises a second body housing the second plurality of electrical contacts, the second plurality of electrical contacts passing through corresponding openings in an outer surface of the second body and having a second predetermined physical relationship. In still another embodiment, the first plurality of electrical contacts comprises a first electrical contact and a second electrical contact, the second plurality of electrical contacts comprises a third electrical contact and a fourth electrical contact, and when the first and second connector assemblies are aligned and brought into proximity, the first electrical contact mates with one of the third electrical contact and fourth electrical contact; and the second electrical contact mates with the other of the third electrical contact and fourth electrical contact. In still yet another embodiment, the first body and the second body are shaped such that the magnetic circuit can be completed with only one alignment of the first body and the second body. In another embodiment, the third and fourth electrical contacts within the second body can be magnetically coupled to one another but are electrically isolated from one another. In yet another embodiment, the magnet is electrically connected to one of the first and second electrical contacts. In still yet another embodiment, at least one of the first and second electrical contacts and the third and fourth electrical contacts is shaped to form one or more predetermined portions of one of an icon and an image associated with one of a brand and a manufacturer of an item of electrical equipment to which the connector assembly relates. In yet another embodiment, a device comprising the above-described connector assembly is provided. In still yet another embodiment, a cable for charging and/or communicating with a device is provided wherein the cable comprises the above-described connector assembly. In another embodiment, the magnetic circuit from the magnet is completed solely via the first plurality of electrical contacts and the second plurality of electrical contacts.

In accordance with another embodiment, there is provided a connector assembly comprising: a first plurality of electrical contacts; wherein when the connector assembly is aligned and brought into proximity with a second connector assembly comprising a magnet and a second plurality of electrical contacts the magnetic attraction of the magnet within the second connector assembly provides connective force to the connector assembly and a magnetic circuit from the magnet is completed through the first plurality of electrical contacts within the connector assembly and the second plurality of electrical contacts within the second connector assembly. In another embodiment, the connector assembly comprises a first body housing the first plurality of electrical contacts, the first plurality of electrical contacts passing through corresponding openings in an outer surface of the first body and having a first predetermined physical relationship; and the second connector assembly comprises a second body housing the magnet and the second plurality of electrical contacts, the second plurality of electrical contacts passing through corresponding openings in an outer surface of the second body and having a second predetermined physical relationship. In another embodiment, the first plurality of electrical contacts comprises a first electrical contact and a second electrical contact, the second plurality of electrical contacts comprises a third electrical contact and a fourth electrical contact, and when the connector assemblies are aligned and brought into proximity, the first electrical contact mates with one of the third electrical contact and fourth electrical contact; and the second electrical contact mates with the other of the third electrical contact and fourth electrical contact. In still another embodiment, the first body and the second body are shaped such that the magnetic circuit can be completed with only one alignment of the first body and the second body. In still yet another embodiment, the first and second electrical contacts within the first body can be magnetically coupled to one another but are electrically isolated from one another. In another embodiment, the magnet is electrically connected to one of the third and fourth electrical contacts. In still another embodiment, at least one of the first and second electrical contacts and the third and fourth electrical contacts is shaped to form one or more predetermined portions of one of an icon and an image associated with one of a brand and a manufacturer of an item of electrical equipment to which the connector assembly relates. In another embodiment, a device comprising the above-described connector assembly is provided. In yet another embodiment, a cable for charging and/or communicating with a device is provided, wherein the cable comprises the above-described connector assembly. In another embodiment, the magnetic circuit from the magnet is completed solely via the first plurality of electrical contacts and the second plurality of electrical contacts.

In accordance with another embodiment, there is provided a device comprising a first connector assembly configured to interact with a second connector assembly disposed at the end of a cable to be connected to the device for charging and/or communicating with the device, wherein: the first connector assembly comprises a first plurality of electrical contacts; the second connector assembly comprises a second plurality of electrical contacts; the second plurality of electrical contacts being adapted to mate with the first plurality of electrical contacts to provide an electrical connection; wherein one of the first connector assembly and the second connector assembly comprises a magnet; wherein when the first and second connector assemblies are aligned and brought into proximity the magnetic attraction of the magnet within one of the first connector assembly and the second connector assembly provides connective force to the other of the first connector assembly and the second connector assembly, and a magnetic circuit from the magnet is completed through the first plurality of electrical contacts and the second plurality of electrical contacts. In another embodiment, the magnetic circuit from the magnet is completed solely via the first plurality of electrical contacts and the second plurality of electrical contacts. The first and second connector assemblies can have other features as described in more detail above.

In further aspects of the above-described embodiments, the magnet is a ring/annular magnet with its poles on the inner and outer surfaces of the ring and the first plurality of electrical contacts form a first circular or annular pattern and the second plurality of electrical contacts form a second circular or annular pattern.

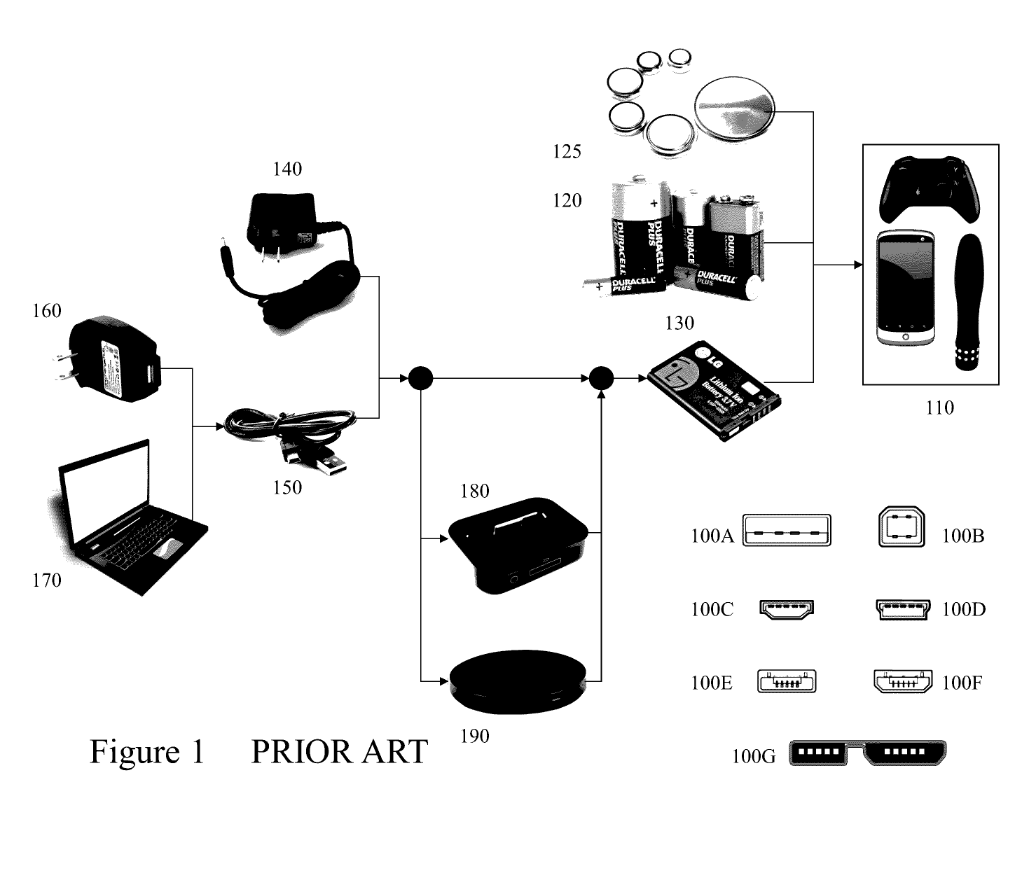

Referring to FIG. 1 there is depicted typical electrical power interfaces for portable electronic devices (PEDs) 110 according to the prior art. PEDs 110 may employ replaceable disposable batteries 120 such as AA and AAA, for example, although some may use larger C or D type batteries. Others may employ one or more button cell batteries 125 denoted by codes such as XXYYZZ, where XX is type of cell (CR=lithium, LR=alkaline/silver, SR=silver), YY is nominal cell diameter in millimeters and ZZ is cell height in tenths of millimeter (e.g. 54=5.4 mm). However, in many instances a “custom” battery 130 which is shaped and designed to the device will be employed in order to provide flexibility in design and performance to meet the demands of the PED or wearable electronic device (WED). These are then connected to a docking station 180 in some instances, a connector cable 150 in others, and AC-DC transformers 140 in others via standard connectors such as first to seventh Universal Serial Bus (USB) connectors 100A to 100G depicting USB A, USB B, USB mini A, USB mini B, USB micro A, USB micro B, and USB 3.0 respectively.

First and second USB connectors 100A and 100B are typically employed on larger PEDs such as laptops, printers, etc. whilst third to sixth connectors 100C to 100F are typically employed on PEDs and WEDs. Seventh connector 100G which supports higher speed connections (5 Gb/s) than the USB 1.1 and USB 2.0 standards (12 Mb/s and 480 Mb/s) is typically employed on external portable hard disk drives etc. However, the majority of PEDs/WEDs never reach a fraction of the supported transfer rates of the standards. Other standard interfaces are typically push on/pull off coaxial designs. Connector cable 150 may be connected to an AC power adapter 160 providing DC power according to the USB standards, for example, or a PED 170 such as a laptop wherein the PED 170 provides DC power through the USB cable/connectors according to the USB standards.

Further, in many instances even these connectors are too large for many PEDs/WEDs or fail to meet other requirements or aspects of the PED/WED such as resistance to water, moisture, oils, greases, and other materials. In some instances, this has led to the adoption of magnetic induction charging using generic or specific induction charging bases, such as generic induction charger 190, which exploit electromagnetic coupling from an antenna in the induction charging base to an antenna within the PED/WED to transfer power to the PED/WED. However, with small PEDs/WEDs such induction charging is slow even with specific induction charging bases designed to the PED/WED and can become highly inefficient on generic induction charging bases, such as generic induction charger 190, which allow multiple devices to be placed as well work across multiple device geometries and types. Accordingly, as described supra magnetic coupling offers benefits in that connector “real estate” on the PCB within the PED/WED can, with appropriate design methodologies, be freed and small easily damaged connectors/receptacles are replaced by surfaces with some or no contouring. Further, connectors may be embedded within encapsulants allowing sealing from fluid ingress.

As noted supra within the prior art magnetic connectors have been described with many design variants over the past 80 years. However, as the surface area of the two magnetically attracted halves of the connector determines the number of magnetic flux lines and therefore the magnetic holding force between them much of the prior art has been provide two magnetically attracted halves that are as large as possible. However, as already noted above the goal for many PEDs/WEDs is to minimize physical dimensions, especially thickness, whilst maximizing battery capacity, and lowering costs. As such these goals tend to run counter to the design requirements for magnetic connectors within the art.

Within the prior art the predominant design methodology is to design the magnetic coupling around the electrical connector due to concerns over data signaling. However, in a large number of applications today, use of a connector interface is primarily or solely for providing power, as in most instances all other communications to/from the device are predominately through one or more wireless interfaces. This power interface is specified as being 5V at 500 mW for general USB connections, although USB charging ports with type C connectors can provide 1.5 A. Accordingly, either such interfaces solely provide power or the data communications through them generally can employ significantly reduced speeds of communications through the electrical connectors. For example, whilst USB 2.0 supports without bus access issues 280 Mb/s a device employing Bluetooth V4 wireless communications only operates at 28 Mb/s and easily transfers video and image data so other aspects such as firmware revisions, biometric data logging etc. are also handled, as their data requirements will generally be far lower.

Accordingly, the inventors have established a design methodology wherein the magnetic and electrical connections between the two halves of a connector for charging and/or communicating with a device such as a PED/WED are the same physical elements. In addition to allowing electrode and magnetic contact areas to be concurrently increased, this arrangement is in contrast to the predominant prior art methodology of separate electrical and magnetic elements that force a tradeoff. Further, flexibility in design of the contact geometry allows magnetically coupled electrical connectors to adopt non-standard geometries as well as more conventional geometries. In addition, the electrical connector configurations described herein are expected to be more waterproof than more traditional plug and socket arrangements.

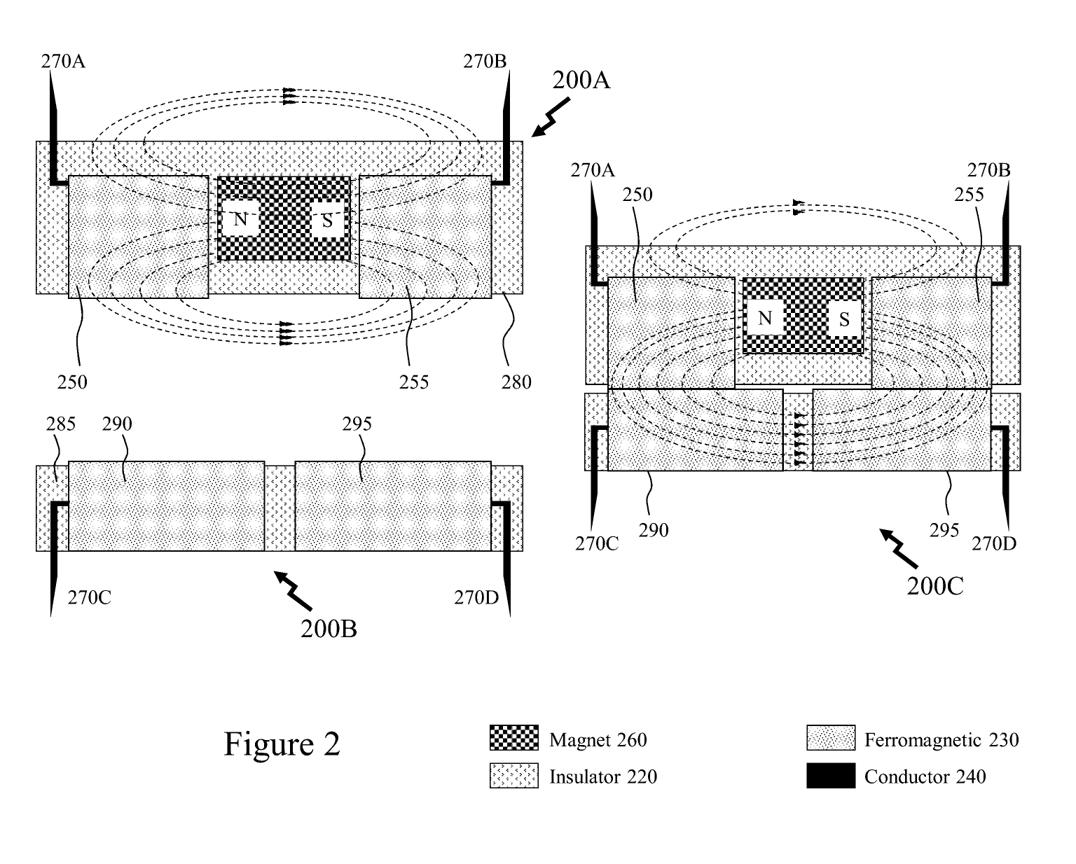

Referring to FIG. 2, there is depicted an electrical connector configuration according to an embodiment of the invention as disassembled first and second assemblies 200A and 200B and assembled connector 200C, respectively. Considering first assembly 200A, disposed within the first body 280 are first and second electrical contacts 250 and 255, respectively, with a magnet 260 disposed between them, wherein each of the first and second electrical contacts 250 and 255, respectively, are connected to first and second electrical leads 270A and 270B, respectively. Accordingly, as depicted, the magnetic field from the magnet 260 couples from the North (N) to South (S) end of the magnet according to convention through the upper and lower portions of the first assembly 200A with magnetic field lines passing through the first and second electrical contacts 250 and 255, respectively. Considering second assembly 200B, disposed within the second body 285 are third and fourth electrical contacts 290 and 295, respectively, which are connected to third and fourth electrical leads 270C and 270D, respectively.

As depicted, first and second bodies 280 and 285 are formed from an insulator 220 which is formed from a suitable material that is electrical insulating but not magnetically insulating, such as solid plastics, flexible plastics, glass, fiber reinforced composites, and ceramics.

First and second electrical contacts 250 and 255, respectively, together with third and fourth electrical contacts 290 and 295, respectively, are formed from a material, such as a ferromagnetic material (depicted as element 230 in FIG. 2), that is electrical conducting and magnetically conductive such as, for example, iron, ferrous alloys, and some stainless steels including, stainless steels 409, 430, 404GP™ and 445M2, for example. Rather than a ferromagnetic material, a paramagnetic material may be employed due to its ability to form internally induced magnetic fields in the direction of applied external magnetic fields. For example, aluminum may be employed. Whilst depicted as a single element, each of the first and second electrical contacts 250 and 255, respectively, together with third and fourth electrical contacts 290 and 295, respectively, may be formed from two or more materials such as, for example, an iron or magnetic stainless steel core with a chromium protective layer against corrosion.

First to fourth electrical leads 270A to 270D are formed from a conductor 240 which may include, but is not limited to, copper, iron, aluminium, nickel, silver, gold, platinum etc. as well as alloys thereof such as brass, stainless steel, etc. and may be magnetic or non-magnetic.

Magnet 260 is formed from a permanent magnetic material including, but not limited to:
ceramic or ferrite magnets that are made of a sintered composite of powdered iron oxide and barium/strontium carbonate ceramic;
alnico magnets that are made by casting or sintering a combination of aluminium, nickel and cobalt with iron and small amounts of other elements added to enhance the properties of the magnet;
injection-molded magnets that are a composite of various types of resin and magnetic powders, allowing parts of complex shapes to be manufactured by injection molding; and
rare-earth magnets such as samarium-cobalt and neodymium-iron-boron (NIB) magnets, for example.

Then, as depicted in assembled connector 200C, when the first and second assemblies 200A and 200B are brought together, third and fourth electrical contacts 290 and 295, respectively, within the second assembly 200B contact the first and second electrical contacts 250 and 255, respectively, providing electrical connection from the first assembly 200A to the second assembly 200B and therefore from, for example, a connector to a device or vice-versa or from a first device to a second device and vice-versa or a first connector to a second connector or vice-versa. At the same time, the third and fourth electrical contacts 290 and 295 within the second assembly 200B, as they are brought into contact with the first and second electrical contacts 250 and 255, respectively, begin to interact with the magnetic field of the magnet 260 and, due to the geometric design methodology of the inventors that they are isolated by a narrow region of insulator 220, they act to form a “preferred” magnetic path, increasing the magnetic flux within them and increasing the magnetic attraction between the first and second electrical contacts 250 and 255, respectively, and the third and fourth electrical contacts 290 and 295, respectively. In this manner, the first and second assemblies 200A and 200B are magnetically and electrically coupled through the same contacts within them.

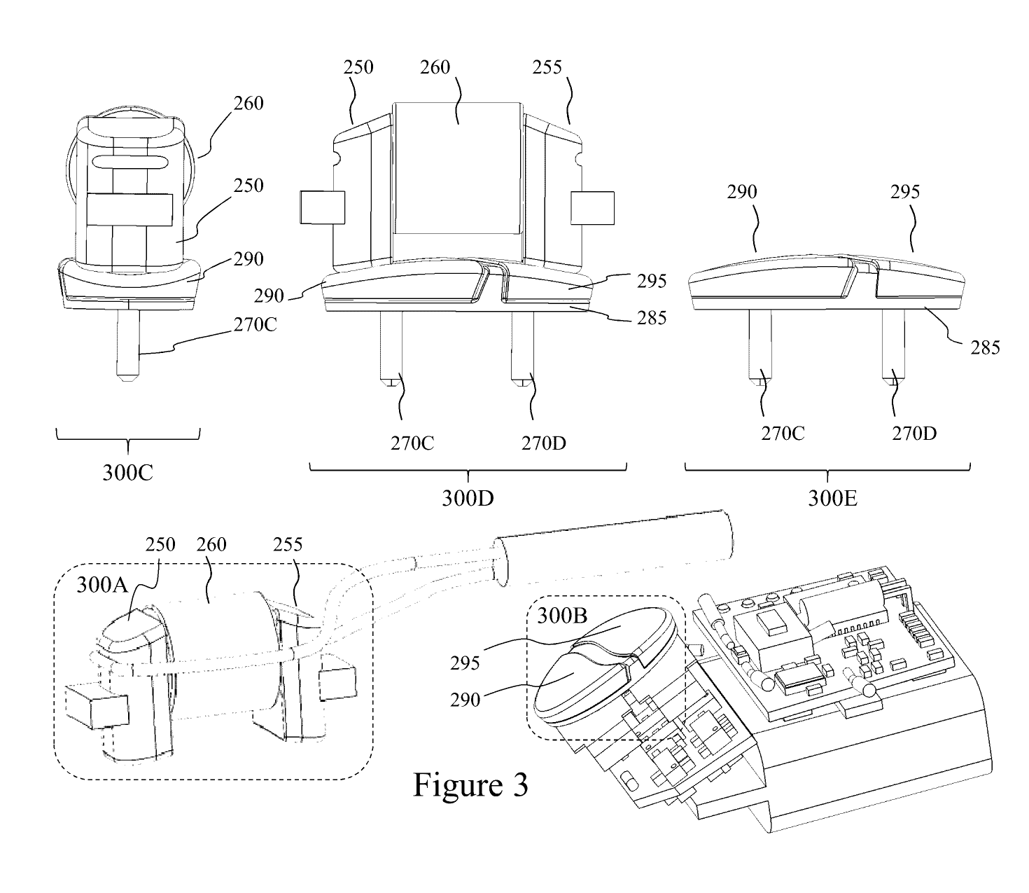

As such, as will become evident from the specification and figures below in respect of FIGS. 3 to 15, the methodology of the inventors allows for a range of numbers and geometries for the electrical contacts and the design—shape—geometry—numbers of magnet(s) employed in the connector assemblies/systems.

Referring to FIG. 3 there is depicted a realization of the electrical connector configuration according to the embodiment of the invention depicted in FIG. 2 in first to fifth images 300A to 300E respectively. Referring to first image 300A there is depicted a connector assembly comprising first and second electrical contacts 250 and 255, respectively, together with magnet 260. Second image 300B depicts third and fourth electrical contacts 290 and 295, respectively, as part of an electronic device. Referring to third image 300C a side view of magnet 260 and first electrical contact 250 in contact with third electrical contact 290 is depicted with third electrical lead 270C. Fourth image 300D depicts a front elevation of magnet 260 with first and second electrical contacts 250 and 255, respectively, as mounted to third and fourth electrical contacts 290 and 295, and therein third and fourth electrical leads 270C and 270D together with second body 285. Fifth image 300E depicts the third and fourth electrical contacts 290 and 295 and therein third and fourth electrical leads 270C and 270D together with second body 285.

Accordingly, in this configuration the first assembly 200A in FIG. 2 would be the connector assembly terminating as depicted in first image 300A in FIG. 3, whilst the second assembly 200B would be the device assembly as depicted in second image 300B in FIG. 3. Optionally, depending upon the design of the connector and PED/WED, these associations may be reversed. However, it is evident in second, fourth and fifth images 300B, 300D and 300E respectively that the third and fourth electrical contacts 290 and 295 are shaped whilst extending towards each other with the insulating second body 285 disposed between them. Accordingly, the device assembly as depicted in second image 300B when encapsulated by the body of the device presents the user with a patterned contact area that is decorative and aesthetic rather than a functional utilitarian electrical socket or connector. In this manner, rather than an electrical connector being hidden away somewhere on the device as it spoils the aesthetic, the connector can become part of the overall aesthetic of the device it forms part of.

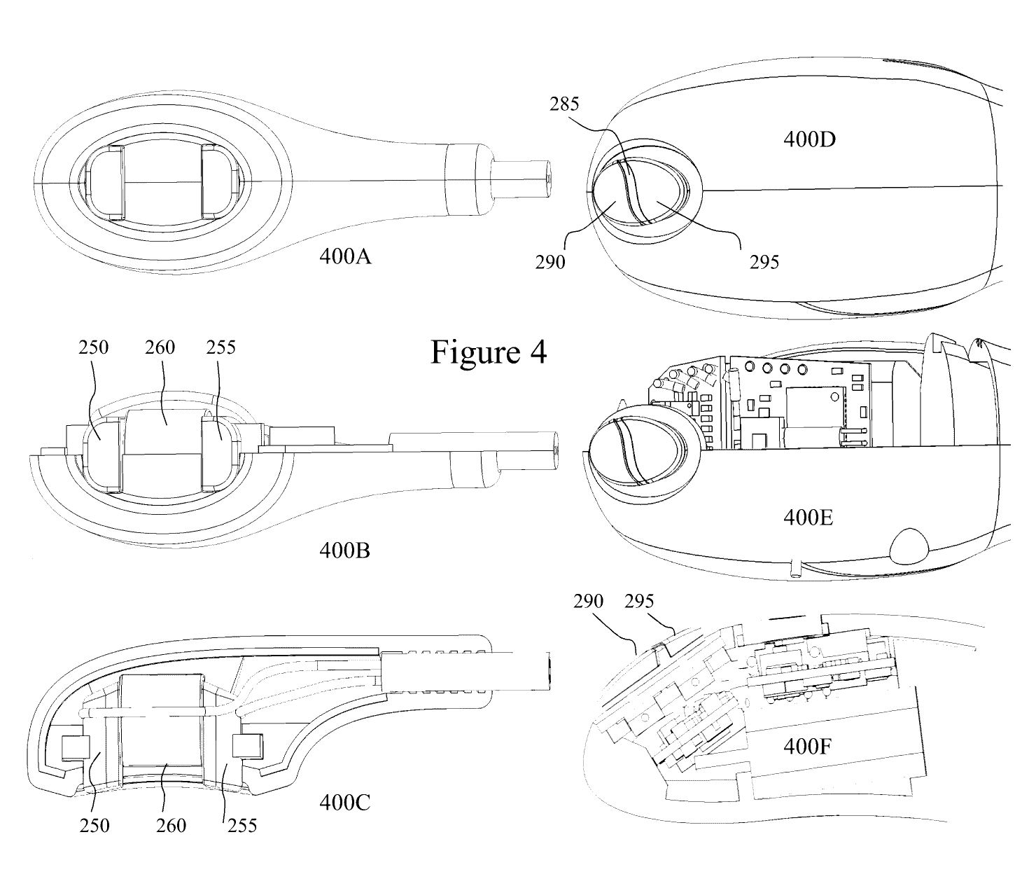

This is evident from FIG. 4 wherein there are depicted first to third connector images 400A to 400C, respectively, and first to third device images 400D to 400F, respectively, for a magnetic electrical connector (MAGELCON) configuration according to the embodiment of the invention depicted in FIGS. 2 and 3. Accordingly, with first device image 400D it can be seen that the third and fourth electrical contacts 290 and 295 are now part of a design upon the body of the device with the insulating second body 285 between them. As depicted:
first connector image 400A and first device image 400D are external assembly views of the connector and device, respectively;
second connector image 400B and second device image 400E are external assembly views of the connector and device, respectively, with half of each respective external assembly removed in bottom/top elevation views; and
third connector image 400C and third device image 400F are external assembly views of the connector and device, respectively, in side elevations towards the respective element where the external assembly has been removed.

As depicted, therefore, it is evident that the electrical connector portion within the device, e.g. as depicted in third device image 400F, has a low physical profile and the third and fourth electrical contacts 290 and 295 are shaped on their upper surfaces to the final profile of the device when the remainder of the assembly is attached and, optionally, the device has been coated with a material such as silicone due to its intended use and/or environment.

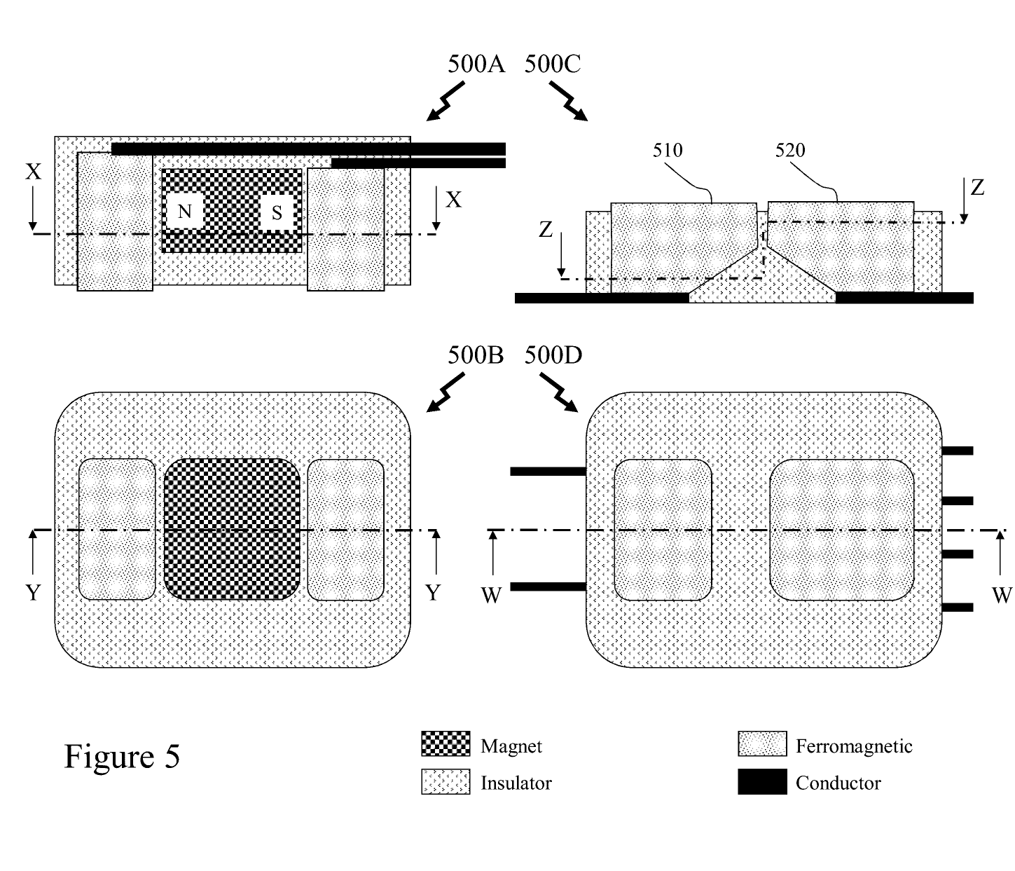

Now referring to FIG. 5, there is depicted an electrical connector configuration according to an embodiment of the invention in first to fourth views 500A to 500D, respectively. As depicted, first view 500A is a cross-section along the section line Y-Y of one connector assembly, second view 500B is a cross-section along the section line X-X of one connector assembly, third view 500C is a cross-section along the section line W-W of the other connector assembly, and fourth view 500D is a cross-section along the section line Z-Z of the other connector assembly. In this instance, the connector design comprises a single contact (first electrical contact) on the N side of the magnet and a single contact (second electrical contact) on the S side of the magnet as with the previous design in FIG. 2. However, the third and fourth electrical contacts 510 and 520 within the other connector assembly, as evident from third view 500C, have a vertical profile that is shaped providing an initial cross-section with small gap between the third and fourth electrical contacts 510 and 520 at the surface mating to the connector assembly depicted in first view 500A which then increases as depth increases. In this manner the magnetic flux is preferentially directed through the surface of the connector assembly with third and fourth electrical contacts 510 and 520, respectively.

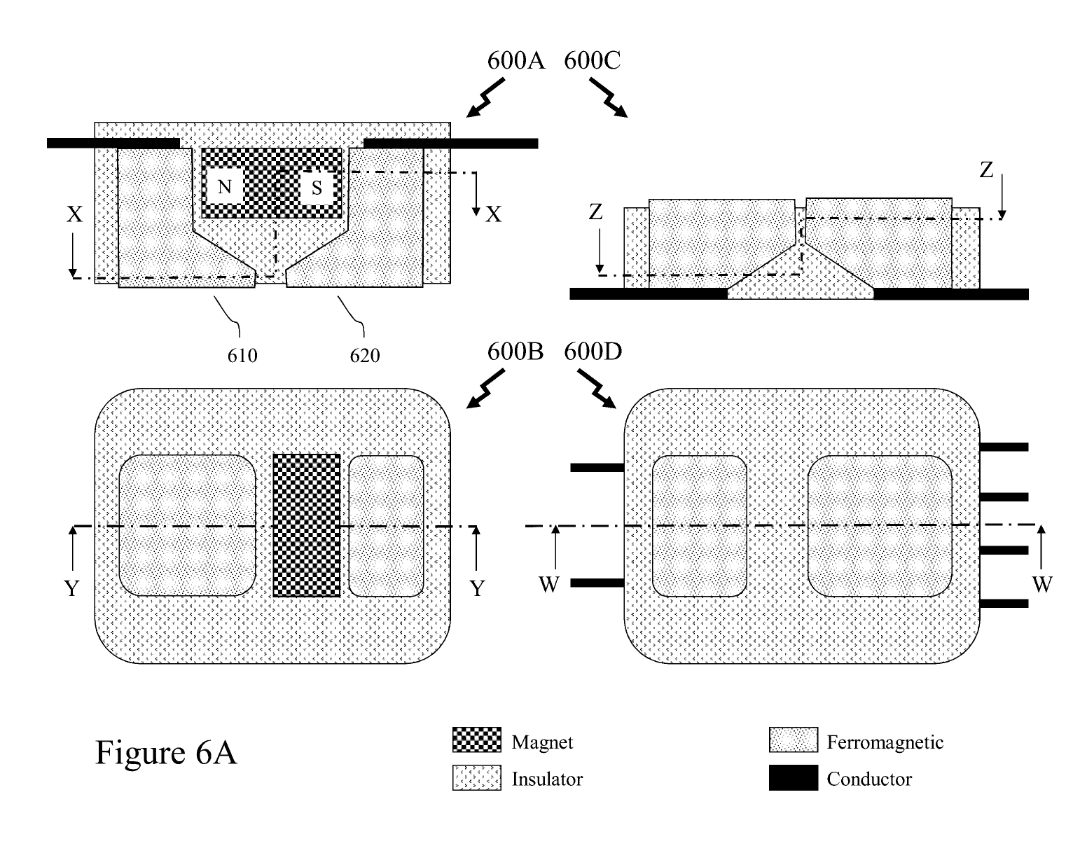

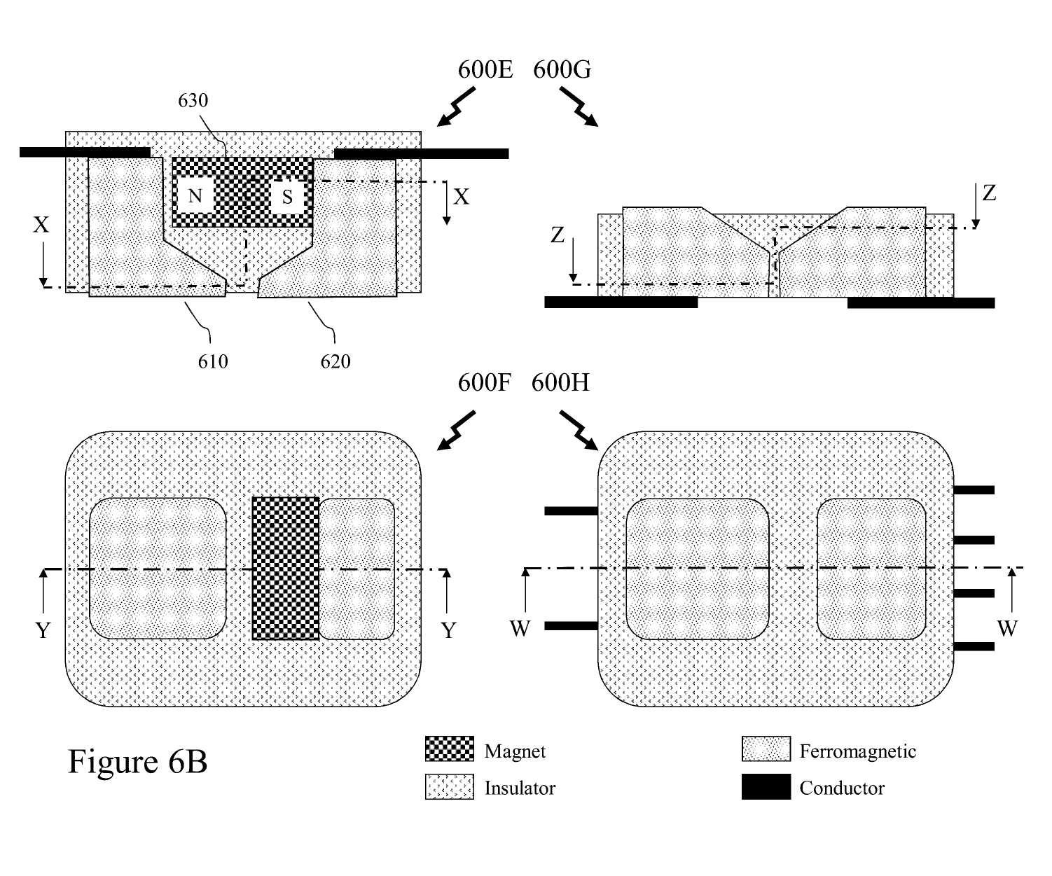

This shaping of electrical contacts increases within FIG. 6A, wherein there is depicted an electrical connector configuration according to an embodiment of the invention with first view 600A being a cross-section along the section line Y-Y of one connector assembly, second view 600B being a cross-section along the section line X-X of one connector assembly, third view 600C is a cross-section along the section line W-W of the other connector assembly, and fourth view 600D is a cross-section along the section line Z-Z of the other connector assembly. Now the first and second electrical contacts 610 and 620 within the connector assembly depicted in first view 600A are shaped to enhance the magnetic field coupling between the two halves of the MAGELCON such that the surface areas of the electrical contacts in each half of the MAGELCON are now increased in area thereby increasing the overlap between them when mated together and thereby increasing the magnetic retention between the two connector portions.

Now referring to FIG. 6B, there is depicted an electrical connector configuration according to an embodiment of the invention which is essentially identical to that depicted in FIG. 6A except that the magnet 630 is now electrically connected to the second electrical contact 620 rather than isolated from each of the first and second electrical contacts 610 and 620 respectively as depicted in FIG. 6A. Optionally, the magnet 630 may be now electrically connected to the first electrical contact 610 and isolated from the second electrical contact 620. FIG. 6B depicts this electrical connector configuration according to an embodiment of the invention with first view 600E is a cross-section along the section line Y-Y of one connector assembly, second view 600F is a cross-section along the section line X-X of one connector assembly, third view 600G is a cross-section along the section line W-W of the other connector assembly, and fourth view 600H is a cross-section along the section line Z-Z of the other connector assembly.

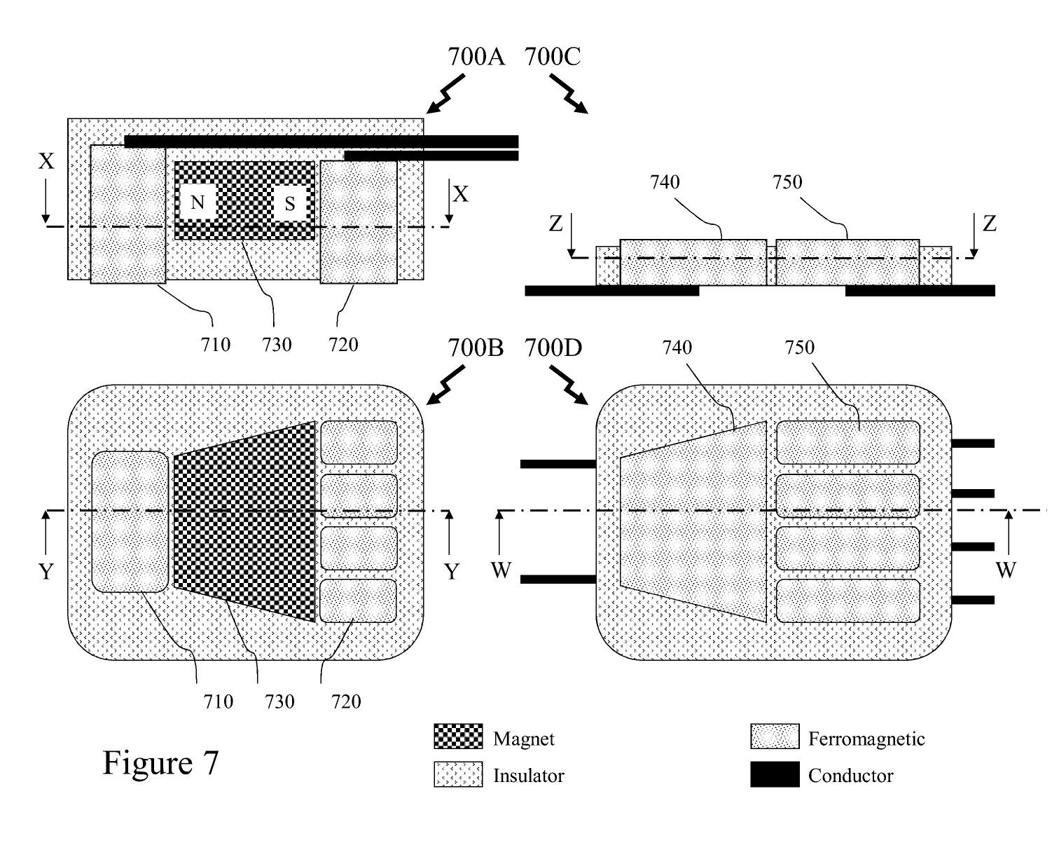

The underlying design methodology of magnetically coupled but electrically isolated contacts within the second portion of the connector whilst the first portion contains a magnet are extended in FIG. 7 where there is depicted an electrical connector configuration according to an embodiment of the invention with single first and third electrical contacts 710 and 740, respectively, and multiple second and fourth electrical contacts 720 and 750, respectively. As depicted, FIG. 7 comprises first view 700A which is a cross-section along the section line Y-Y of one connector assembly, second view 700B which is a cross-section along the section line X-X of one connector assembly, third view 700C which is a cross-section along the section line W-W of the other connector assembly, and fourth view 700D which is a cross-section along the section line Z-Z of the other connector assembly. Accordingly, this may provide, for example, a single ground connection via first and third electrical contacts 710 and 740, respectively, with multiple power and/or signal lines through the multiple second and fourth electrical contacts 720 and 750, respectively.

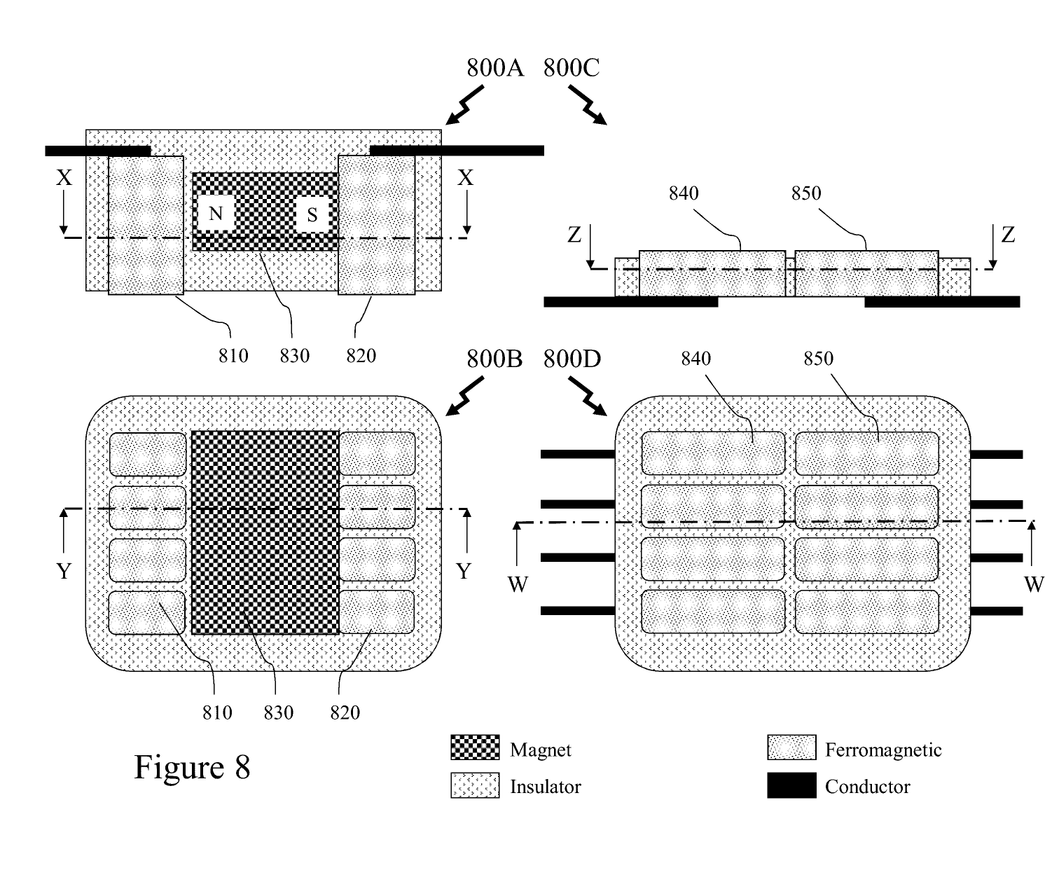

This concept is extended further in FIG. 8, wherein there is depicted an electrical connector configuration according to an embodiment of the invention with multiple first and third electrical contacts 810 and 840, respectively, and multiple second and fourth electrical contacts 820 and 850, respectively. As depicted, FIG. 8 comprises the following views: first view 800A is a cross-section along the section line Y-Y of one connector assembly, second view 800B is a cross-section along the section line X-X of one connector assembly, third view 800C is a cross-section along the section line W-W of the other connector assembly, and fourth view 800D is a cross-section along the section line Z-Z of the other connector assembly. Accordingly, this may provide, for example, a ground connection and power connections via first and third electrical contacts 810 and 840, respectively, with signal lines through the multiple second and fourth electrical contacts 820 and 850, respectively, or vice-versa. Alternatively, each set of 4 electrical connections per “side” of the connector pad may be power—ground—signal—ground, power—ground—signal—signal, or other combinations thereof.

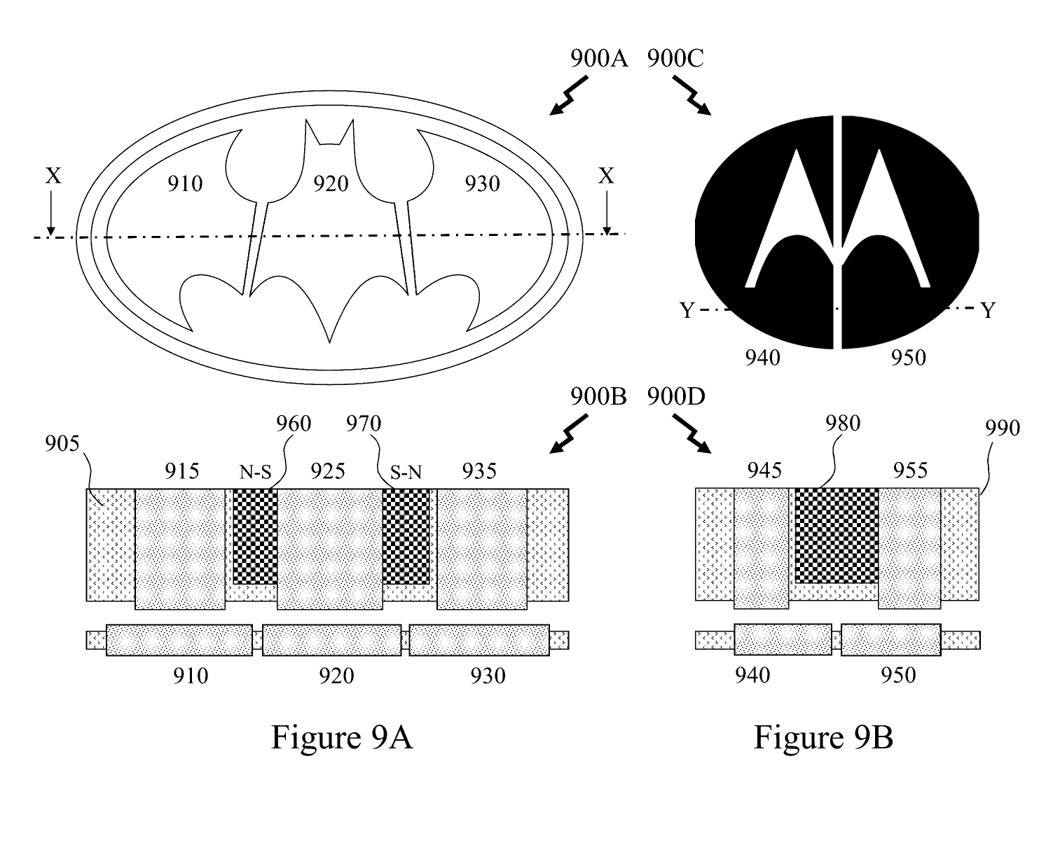

Referring to FIGS. 9A and 9B, there are depicted electrical contact configurations according to embodiments of the invention as implemented with logos upon a device to be connected to a connector. Referring initially to FIG. 9A, there are depicted plan and cross-section views 900A and 900B, respectively, for an electrical connector wherein the portion upon the device being coupled with the connector has the electrical contacts within the shape of the Batman™ logo such that the left and right wings are first and third electrical contacts 910 and 930, respectively, with the central body as second electrical contact 920. These connect as depicted in cross-section 900B to a connector comprising connector body 905 within which are fourth to sixth contacts 915, 925, and 935, respectively. As depicted, fourth and fifth contacts 915 and 925, respectively, are separated by first magnet 960, and fifth and sixth contacts 925 and 935, respectively, are separated by second magnet 970. Accordingly, two magnetic circuits are completed when the connector body is brought into contact with the connector upon the device comprising first to third contacts 910 to 930, respectively. The first magnetic circuit includes first magnet 960, fourth and fifth contacts 915 and 925, respectively, in the connector and first and second contacts 910 and 920, respectively, within the device. The second magnetic circuit includes second magnet 970, fifth and sixth contacts 925 and 935, respectively, in the connector and second and third contacts 920 and 930, respectively, within the device. In this embodiment of the invention, the contacts on the device are “larger” in this region of connection than the contacts in the connector.

Depicted in FIG. 9B are plan and cross-section views 900C and 900D respectively for an electrical connector wherein the portion upon the device being coupled with the connector has the electrical contacts within the shape of the Motorola™ logo. Accordingly, in this instance the first and second electrical contacts 940 and 950, respectively, are left and right halves of the logo which has been split at the mid-point. These then align with third and fourth connector contacts 945 and 955, respectively, within the connector body 990. As such, these first and second electrical contacts 940 and 950, respectively, close the magnetic circuit from the magnet 980 in conjunction with the third and fourth connector contacts 945 and 955, respectively.

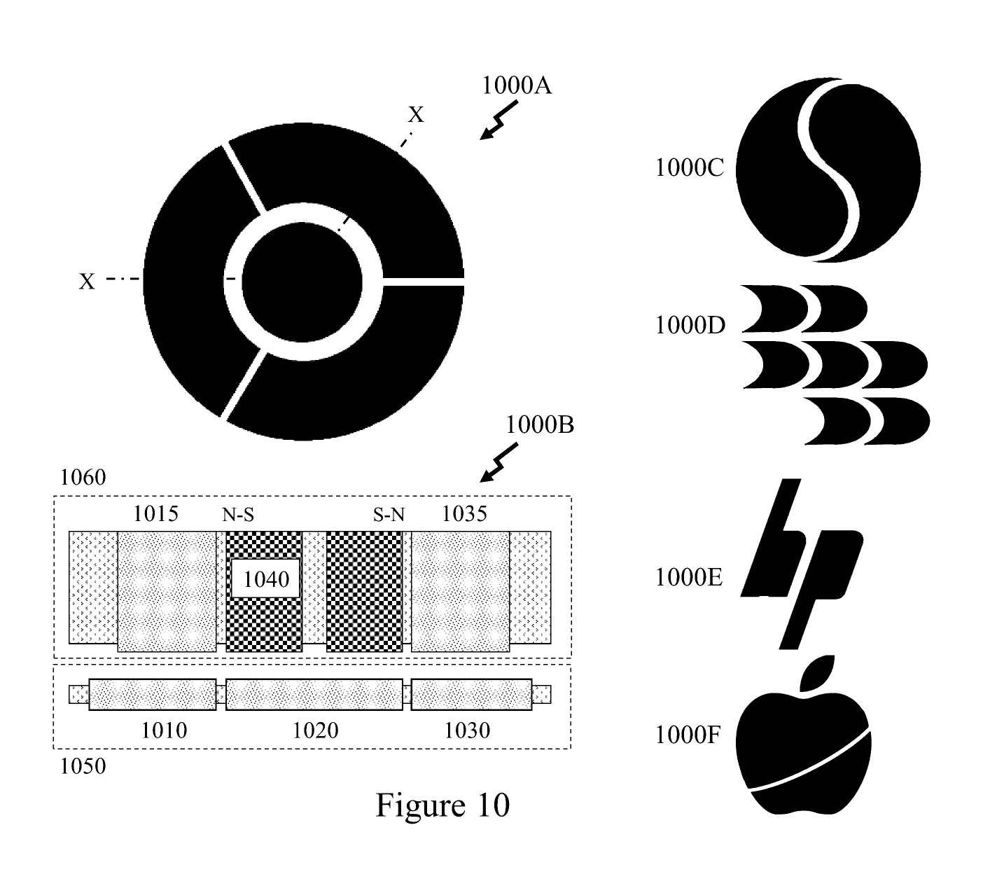

Now referring to FIG. 10, there are depicted electrical contact configurations according to embodiments of the invention as implemented with logos upon a device to be connected to a connector. Accordingly, within first schematic 1000A the Google™ Chrome icon is depicted together with cross-section X-X in second schematic 1000B with device portion 1050 and connector portion 1060 of an electrical connection according to an embodiment of the invention. As depicted, the device portion 1050 has first to third contacts 1010, 1020, and 1030, respectively. Second contact 1020 is a circular contact aligning to the magnet 1040 whilst first and third contacts 1010 and 1030 represent annular electrodes that align to fourth and fifth contacts 1015 and 1035, respectively. As depicted, magnet 1040, rather than being a magnet with poles at opposite ends, is an annular (ring) magnet with poles on the inner and outer surfaces. Accordingly, the connection of connector portion 1060 to device portion 1050 results in the magnetic circuit being completed from the magnet 1040 through the annular connector electrodes, of which fourth and fifth contacts 1015 and 1035 are two of the three, through the annular device sections within the device portion, of which first and third contacts 1010 and 1030 are two of the three, and the central contact 1020.

Also depicted in FIG. 10 are third to sixth schematics 1000C to 1000F respectively representing device portion contacts shaped in the form of Pepsi-Cola™, Blackberry™, Hewlett Packard™, and Apple™, respectively. Accordingly, it would be evident that many icons representing brands can be integrated into electrical contacts according to embodiments of the invention as well as more standard electrode configurations. It would be evident that whilst the descriptions supra in respect of icons have been primarily made with respect to the device portion of an electrical connector assembly that the icon may be similarly visible when the electrical contacts on the connector are viewed. It would also be evident that the functionality of the first and second portions of the electrical connector designs depicted in respect of FIGS. 2 to 10 respectively may be “reversed” without changing the underlying design principles. Accordingly, whilst a first portion may have been described and depicted as being a first part of an electrical connector on an electrical cable and that the second portion may have been described and depicted as being a second part of an electrical connector on an electrical device it would be evident that the first portion may be, alternatively, on the electrical device and the second portion would then be on the electrical cable. Optionally, the electrical connectors may be cable—cable connections or for electrical device to device connections, cable to PCB, PCB-PCB, etc. without departing from the scope of the invention.

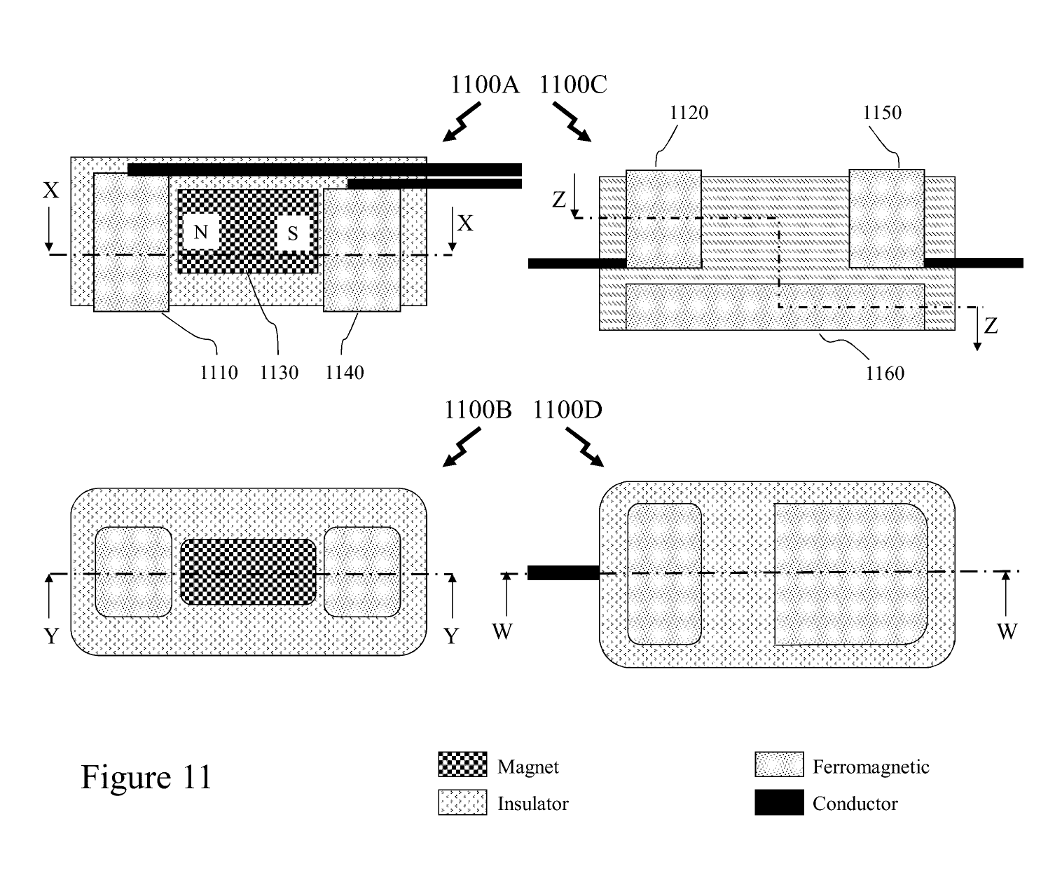

The underlying design methodology of magnetically coupled but electrically isolated contacts within a second portion of a connector whilst a first portion of the connector contains a magnet are extended in FIG. 11 wherein there is depicted an electrical connector configuration according to an embodiment of the invention with the magnetic loop completed through a ferromagnetic material disposed within the second portion of the connector rather than where the electrical contacts solely provide the magnetic loop closure as depicted in FIGS. 2 to 10, respectively. Accordingly, first and second electrical contacts 1110 and 1140, respectively, couple to third and fourth electrical contacts 1120 and 1150, respectively. As depicted, FIG. 11 comprises: first view 1100A—a cross-section along the section line Y-Y of a first connector assembly; second view 1100B—a cross-section along the section line X-X of the first connector assembly; third view 1100C—a cross-section along the section line W-W of a second connector assembly; and fourth view 1100D—a cross-section along the section line Z-Z of the second connector assembly.

Accordingly, as depicted, the first connector assembly further includes a magnet 1130 disposed between the first and second electrical contacts 1110 and 1140, respectively, whilst disposed behind the third and fourth electrical contacts 1120 and 1150 respectively is ferromagnetic element 1160. Hence, a magnetic loop is formed from one pole of the magnet to its other pole via the first electrical contact 1110, third electrical contact 1120, ferromagnetic element 1160, fourth contact 1150 and second contact 1140. For example, a ground connection may be coupled via first and third electrical contacts 1110 and 1120, respectively, and a power and/or data line through the second and fourth electrical contacts 1140 and 1150 respectively. The first connector assembly may be part of a cable whilst second connector assembly may be part of a device or vice-versa. Electrical isolation but magnetic loop closure between the electrical contacts within the first and second connector assemblies is achieved by the magnet 1130 and ferromagnetic element 1160 being electrically isolated via the body of the connector assemblies from the electrical contacts, e.g. plastic. As such the magnetic flux can close the loop without electrical conductivity. Optionally, the ferromagnetic element 1160 and magnet 1130 may touch one contact such that an improved magnetic coupling is achieved but electrical isolation maintained.

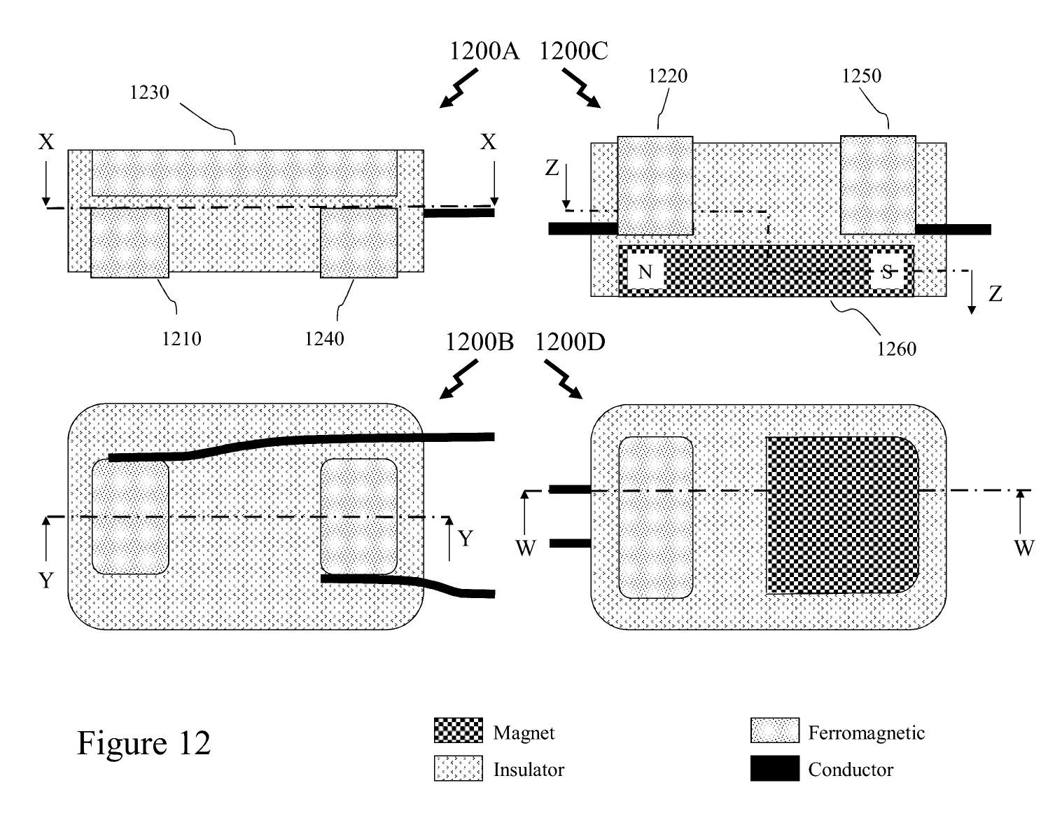

Now referring to FIG. 12, there is depicted an electrical connector configuration according to an embodiment of the invention wherein first and second electrical contacts 1210 and 1240, respectively, couple to third and fourth electrical contacts 1220 and 1250, respectively, and form part of a magnetic loop with ferromagnetic element 1230 and magnet 1260. Depicted in FIG. 12 are first view 1200A—a cross-section along the section line Y-Y of a first connector assembly; second view 1200B—a cross-section along the section line X-X of the first connector assembly; third view 1200C—a cross-section along the section line W-W of a second connector assembly; and fourth view 1200D—a cross-section along the section line Z-Z of the second connector assembly. Accordingly, a magnetic loop is formed from one pole of the magnet 1260 to its other pole via the second electrical contact 1240, first electrical contact 1210, ferromagnetic element 1230, third electrical contact 1220 and fourth electrical contact 1250. For example, a ground connection may be coupled via first and third electrical contacts 1210 and 1220, respectively, and a power and/or data line through the second and fourth electrical contacts 1240 and 1250, respectively. The first connector assembly may be part of a cable whilst second connector assembly may be part of a device or vice-versa. As charging cables etc. are generally left lying around and/or dropped etc. in contrast to the electronic device they can be more prone to collecting debris which is magnetic onto the contacts of the cable end of the connector pair. As such in some instances the magnet 1260 is within the device portion of the connector pair.

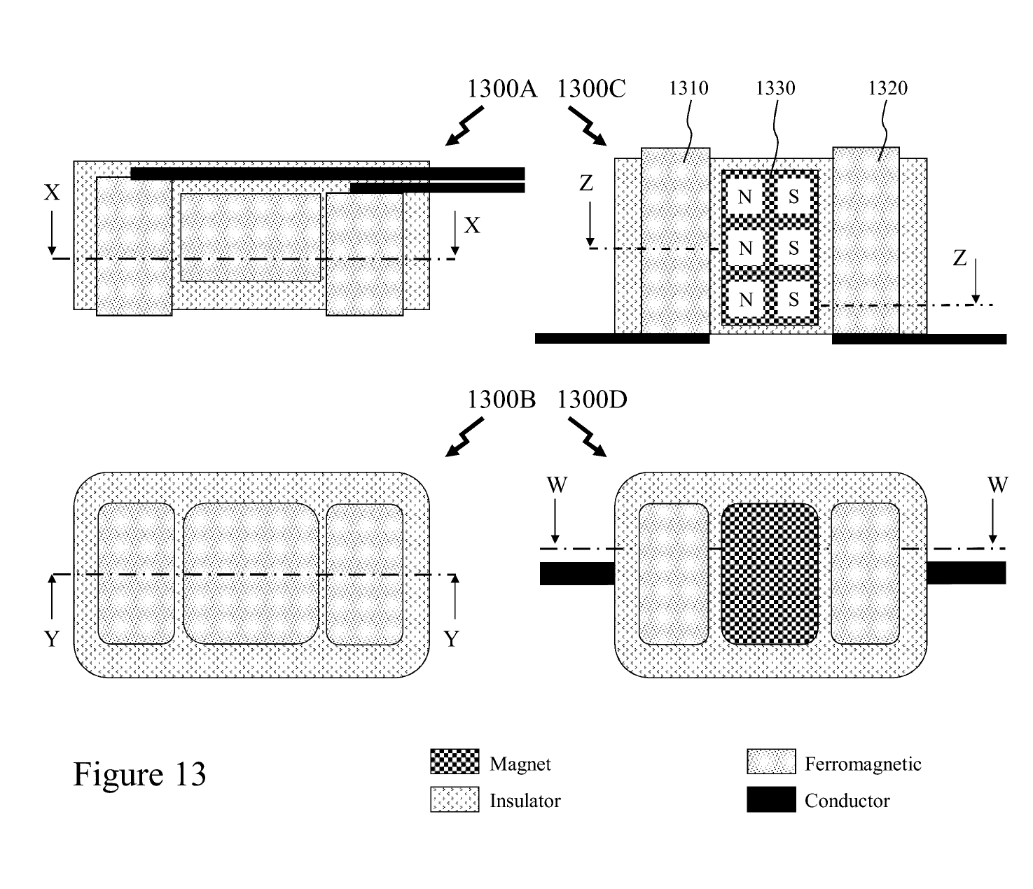

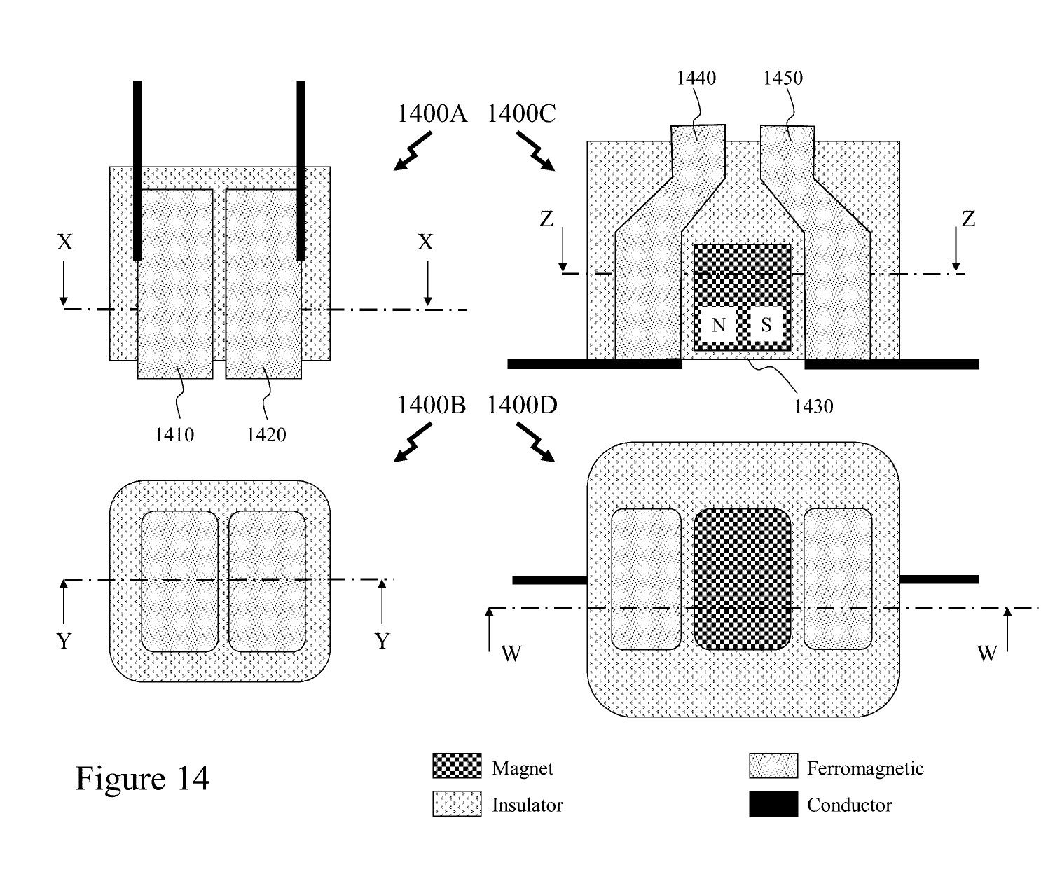

Referring to FIG. 13, there is depicted an electrical connector configuration according to an embodiment of the invention with the same configuration of first to fourth views 1300A to 1300D, respectively, in front and plan cross-sectional views of the first and second connector assemblies along section lines Y-Y, X-X, W-W and Z-Z, respectively. In contrast to the preceding embodiments of the invention, the magnet 1330 between the pair of electrical contacts 1310 and 1320 within the second connector assembly depicted in third and fourth views 1300C and 1300D, respectively, is coupled to a larger portion of the electrical contacts. Due to the configuration, magnet 1330 may be machined from a standard bar magnet or molded etc. This is extended further in FIG. 14 wherein increased overlap between the electrical contacts within the first connector assembly depicted in first and second views 1400A and 1400B results in removal of the ferromagnetic element.

Accordingly, referring to FIG. 14 there is depicted an electrical connector configuration according to an embodiment of the invention with the same configuration of first to fourth views 1400A to 1400D, respectively, in front and plan cross-sectional views of the first and second connector assemblies along section lines Y-Y, X-X, W-W and Z-Z, respectively. Accordingly, the first connector assembly exploits long ferromagnetic pins 1410 and 1420 which couple to the third and fourth ferromagnetic pins 1440 and 1450, respectively, within the second connector assembly. Disposed between the third and fourth ferromagnetic pins 1440 and 1450, respectively, is the magnet 1430. Accordingly, the magnetic loop is now formed from the magnet 1430 via third ferromagnetic pin 1440, first ferromagnetic pin 1410, second ferromagnetic pin 1420, and fourth ferromagnetic pin 1450 to the other pole of the magnet 1430. By appropriate design of the third and fourth ferromagnetic pins 1440 and 1450, respectively, the magnetic flux can be increased through the exposed surfaces of the ferromagnetic pins increasing the retention force of the magnetic coupling. As with preceding embodiments of the invention the first and second connector assemblies may be cable—device, device—cable, cable—cable or device—device interfaces.

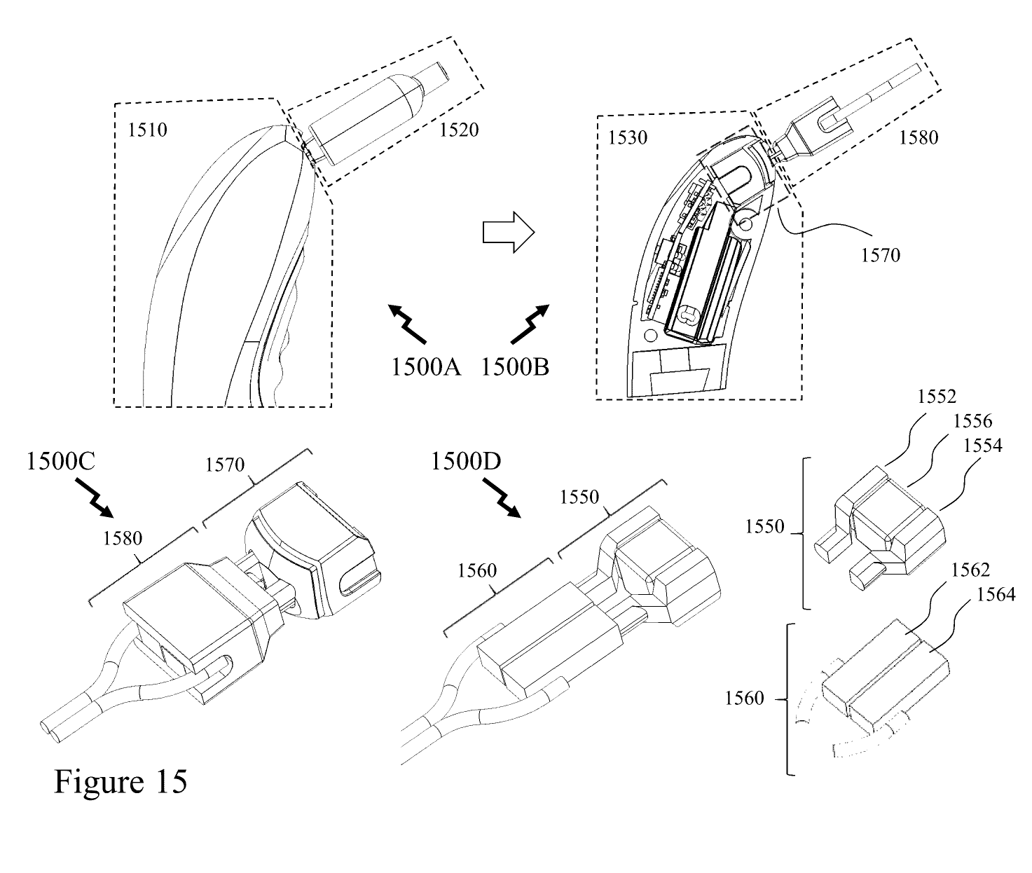

Referring to FIG. 15, there is depicted in first to fourth views 1500A to 1500D a realization of an electrical connector configuration according to the embodiment of the invention depicted in FIG. 14 employing a first connector assembly 1560 with first and second ferromagnetic pins 1562 and 1564, respectively, together with second connector assembly 1550 with third and fourth ferromagnetic pins 1552 and 1554, respectively, and magnet 1556. Each of the first and second connector assemblies 1560 and 1550 being depicted without their shell assemblies which are evident in third view 1500C with first and second connector shell assemblies 1580 and 1570, respectively. Fourth view 1500D depicts the first and second connector assemblies 1560 and 1550 without shells.

These are then depicted in first and second views 1500A and 1500B, respectively, as being employed upon a cable 1520 and device 1510. As depicted in first view 1500A, the consumer device 1510 is presented in user form with a silicone molded overlay over an inner skeleton/shell as is cable 1520. These are then depicted in second view 1500B in the same front elevation view but without the silicone moldings and with the front facing portion of the skeleton/shell removed to expose the internal configuration of the consumer device 1510 and device assembly 1530. Accordingly, there is depicted first connector shell assembly 1580 attached to the tip of the device assembly 1530, whilst the second connector shell assembly 1570 is disposed within the tip of the device assembly 1530.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of mating two electrical connectors to provide an electrical connection and a magnetic connection therebetween, the method comprising:
bringing a first electrical connector comprising a magnet and a first plurality of electrical contacts into proximity with a second electrical connector comprising a second plurality of electrical contacts such that the first plurality of electrical contacts mates with the second plurality of electrical contacts to provide the electrical connection, and a magnetic circuit is completed from the magnet via the first plurality of electrical contacts and the second plurality of electrical contacts to provide the magnetic connection.

2. An electrical connector comprising a first plurality of electrical contacts and configured to be electrically and magnetically connected to a second electrical connector comprising a second plurality of electrical contacts,
wherein one of the electrical connector and the second electrical connector comprises a magnet,
such that when the electrical connector is brought into proximity with the second electrical connector, the first plurality of electrical contacts mates with the second plurality of electrical contacts to provide an electrical connection and a magnetic circuit is completed from the magnet via the first plurality of electrical contacts and the second plurality of electrical contacts to provide a magnetic connection.

3. A magnetic connector system comprising:
a first connector assembly comprising a magnet and a first plurality of electrical contacts; and
a second connector assembly comprising a second plurality of electrical contacts;
the second plurality of electrical contacts being adapted to mate with the first plurality of electrical contacts to provide an electrical connection;
wherein when the first and second connector assemblies are aligned and brought into proximity the magnetic attraction of the magnet within the first connector assembly provides connective force to the second connector assembly and a magnetic circuit from the magnet is completed through the first plurality of electrical contacts and the second plurality of electrical contacts.

4. The magnetic connector system of claim 3, wherein the first connector assembly comprises a first body housing the magnet and the first plurality of electrical contacts, the first plurality of electrical contacts passing through corresponding openings in an outer surface of the first body and having a first predetermined physical relationship; and
the second connector assembly comprises a second body housing the second plurality of electrical contacts, the second plurality of electrical contacts passing through corresponding openings in an outer surface of the second body and having a second predetermined physical relationship.

5. The magnetic connector system of claim 4, wherein the first plurality of electrical contacts comprises a first electrical contact and a second electrical contact, the second plurality of electrical contacts comprises a third electrical contact and a fourth electrical contact, and when the first and second connector assemblies are aligned and brought into proximity, the first electrical contact mates with one of the third electrical contact and fourth electrical contact; and the second electrical contact mates with the other of the third electrical contact and fourth electrical contact.

6. The magnetic connector system of claim 4, wherein the first body and the second body are shaped such that the magnetic circuit can be completed with only one alignment of the first body and the second body.

7. The magnetic connector system of claim 5, wherein the third and fourth electrical contacts within the second body can be magnetically coupled to one another but are electrically isolated from one another.

8. The magnetic connector system of claim 5, wherein the magnet is electrically connected to one of the first and second electrical contacts.

9. The magnetic connector system of claim 5, wherein at least one of the first and second electrical contacts and the third and fourth electrical contacts is shaped to form one or more predetermined portions of one of an icon and an image associated with one of a brand and a manufacturer of an item of electrical equipment to which the magnetic connector system relates.

10. The magnetic connector system of claim 3, wherein one of the first connector assembly and the second connector assembly is housed within a device, and the other of the first connector assembly and the second connector assembly is housed within a cable for charging and/or communicating with the device.

11. A connector assembly comprising:
a magnet; and
a first plurality of electrical contacts;
wherein when the connector assembly is aligned and brought into proximity with a second connector assembly comprising a second plurality of electrical contacts the magnetic attraction of the magnet within the connector assembly provides connective force to the second connector assembly and a magnetic circuit from the magnet is completed through the first plurality of electrical contacts within the connector assembly and the second plurality of electrical contacts within the second connector assembly.

12. The connector assembly of claim 11, wherein the connector assembly comprises a first body housing the magnet and the first plurality of electrical contacts, the first plurality of electrical contacts passing through corresponding openings in an outer surface of the first body and having a first predetermined physical relationship; and
the second connector assembly comprises a second body housing the second plurality of electrical contacts, the second plurality of electrical contacts passing through corresponding openings in an outer surface of the second body and having a second predetermined physical relationship.

13. The connector assembly of claim 12, wherein the first plurality of electrical contacts comprises a first electrical contact and a second electrical contact, the second plurality of electrical contacts comprises a third electrical contact and a fourth electrical contact, and when the connector assemblies are aligned and brought into proximity, the first electrical contact mates with one of the third electrical contact and fourth electrical contact; and
the second electrical contact mates with the other of the third electrical contact and fourth electrical contact.

14. The connector assembly of claim 12, wherein the first body and the second body are shaped such that the magnetic circuit can be completed with only one alignment of the first body and the second body.

15. The connector assembly of claim 13, wherein the third and fourth electrical contacts within the second body can be magnetically coupled to one another but are electrically isolated from one another.

16. The connector assembly of claim 13, wherein the magnet is electrically connected to one of the first and second electrical contacts.

17. The connector assembly of claim 13, wherein at least one of the first and second electrical contacts and the third and fourth electrical contacts is shaped to form one or more predetermined portions of one of an icon and an image associated with one of a brand and a manufacturer of an item of electrical equipment to which the connector assembly relates.

18. A device comprising the connector assembly of claim 11.

19. A cable for charging and/or communicating with a device comprising the connector assembly of claim 11.

20. A connector assembly comprising:
a first plurality of electrical contacts;
wherein when the connector assembly is aligned and brought into proximity with a second connector assembly comprising a magnet and a second plurality of electrical contacts the magnetic attraction of the magnet within the second connector assembly provides connective force to the connector assembly and a magnetic circuit from the magnet is completed through the first plurality of electrical contacts within the connector assembly and the second plurality of electrical contacts within the second connector assembly.

21. The connector assembly of claim 20, wherein the connector assembly comprises a first body housing the first plurality of electrical contacts, the first plurality of electrical contacts passing through corresponding openings in an outer surface of the first body and having a first predetermined physical relationship; and
the second connector assembly comprises a second body housing the magnet and the second plurality of electrical contacts, the second plurality of electrical contacts passing through corresponding openings in an outer surface of the second body and having a second predetermined physical relationship.

22. The connector assembly of claim 21, wherein the first plurality of electrical contacts comprises a first electrical contact and a second electrical contact, the second plurality of electrical contacts comprises a third electrical contact and a fourth electrical contact, and when the connector assemblies are aligned and brought into proximity, the first electrical contact mates with one of the third electrical contact and fourth electrical contact; and
the second electrical contact mates with the other of the third electrical contact and fourth electrical contact.

23. The connector assembly of claim 21, wherein the first body and the second body are shaped such that the magnetic circuit can be completed with only one alignment of the first body and the second body.

24. The connector assembly of claim 22, wherein the first and second electrical contacts within the first body can be magnetically coupled to one another but are electrically isolated from one another.

25. The connector assembly of claim 24, wherein the magnet is electrically connected to one of the third and fourth electrical contacts.

26. The connector assembly of claim 22, wherein at least one of the first and second electrical contacts and the third and fourth electrical contacts is shaped to form one or more predetermined portions of one of an icon and an image associated with one of a brand and a manufacturer of an item of electrical equipment to which the connector assembly relates.

27. A device comprising the connector assembly of claim 20.

28. A cable for charging and/or communicating with a device comprising the connector assembly of claim 20.

29. A device comprising a first connector assembly configured to interact with a second connector assembly disposed at an end of a cable to be connected to the device for charging and/or communicating with the device, wherein:
the first connector assembly comprises a first plurality of electrical contacts;
the second connector assembly comprises a second plurality of electrical contacts;
the second plurality of electrical contacts being adapted to mate with the first plurality of electrical contacts to provide an electrical connection;
wherein one of the first connector assembly and the second connector assembly comprises a magnet;
wherein when the first and second connector assemblies are aligned and brought into proximity the magnetic attraction of the magnet within one of the first connector assembly and the second connector assembly provides connective force to the other of the first connector assembly and the second connector assembly, and a magnetic circuit from the magnet is completed through the first plurality of electrical contacts and the second plurality of electrical contacts.
